(19) United States
(12) Patent Application Publication
(10) Pub. No.: US 2010/0291374 A1
(43) Pub. Date: Nov. 18, 2010

(54) Composites Comprising Nanoparticles

(75) Inventors: Murat Akarsu, Tucson, AZ (US); Anoop Agrawal, Tucson, AZ (US)

Correspondence Address: LAWRENCE R. OREMLAND, P.C., 5055 E. BROADWAY BLVD., SUITE C-214, TUCSON, AZ, 85711, US

(73) Assignee: AJJER LLC, Tucson, AZ (US)

(21) Appl. No.: 12/843,799

(22) Filed: Jul. 26, 2010

Related U.S. Application Data
(63) Continuation-in-part of application No. 12/136,407, filed on Jun. 10, 2008.
Application No. 12/136,407 is a continuation-in-part of application No. 12/468,719, filed on May 19, 2009.
Application No. 12/468,719 is a continuation-in-part of application No. 12/607,281, filed on Oct. 28, 2009.
(60) Provisional application No. 60/934,247, filed on Jun. 12, 2007.
(60) Provisional application No. 61/054,235, filed on May 19, 2008.
(60) Provisional application No. 61/110,530, filed on Oct. 31, 2008.

(51) Int. Cl. B32B 5/16; B29B 9/00; B29B 9/12

(52) U.S. Cl. 428/328; 264/5; 977/950

(57) ABSTRACT

This invention discloses composite materials utilizing high refractive index materials, their manufacturing methods and their use. Some of the preferred applications are in LED packaging and as deformable fillers in polymers.

### RELATED APPLICATION/CLAIM OF PRIORITY

This application is a continuation-in-part (CIP) of each of the following applications:
(a) U.S. patent application Ser. No. 12/136,407, filed Jun. 10, 2008 (published as 20080311380) and related to provisional application 60/934,247 filed on Jun. 12, 2007;
(b) U.S. patent application Ser. No. 12/468,719 filed on May 19, 2009 (published as US 20100039690) and related to provisional application 61/054,235, filed on May 19, 2008, and
(c) U.S. patent application Ser. No. 12/607,281, filed on Oct. 28, 2009 (published as 20100044640) and related to provisional application 61/110,530 filed Oct. 31, 2008.

### GOVERNMENT RIGHTS

This invention was made with US Government support under contract DE-SC0001309 awarded by the Department of Energy. The Government has certain rights in this invention.

All of the applications referenced above are incorporated by reference herein.

### FIELD OF THE INVENTION

The present invention relates to forming composites of ionic materials and nanoparticles and their applications. The ionic materials comprise ionic liquids and ionic polymers, and nanoparticles comprise of metals and metal compounds. This invention also includes novel processes for forming nanoparticles which have negligible water soluble ionic impurities and can be used to form the composites of this invention. These composites and the ionic materials could be used in a variety of applications including optical, electronic and electrochemical devices and components.

### BACKGROUND OF THE INVENTION

In many optical applications high refractive index materials are required to achieve a desired performance. We discovered that when nanoparticles are dispersed in a matrix, the presence of ionic materials help in obtaining a better dispersion of these nanoparticles which improves the performance of the composite. This discovery may be used to make high refractive index (RI) materials (or composites) where high refractive index nanoparticles are dispersed in lower index matrices comprising ionic materials, e.g., ionic liquids. The superior dispersion results in optically clear composites where the RI of the composite is higher than the RI of the matrix. For some applications the optical clarity of these composites is important, which means low haze and absence of coloration. Some of the applications where high refractive index materials can be used fruitfully are optical elements (lenses, beam splitters, waveguides), optical coatings, fiber optic applications, scintillators, displays, light emitting diode packaging, optical communication and optical computing. The high index materials may also be used in electrochemical systems, such as electrolytes for electrochromic devices, where the RI of the electrodes and the electrolytes is matched to decrease light loss at the interface. The use of high index encapsulants to increase the light extraction efficiency in light emitting diodes (LEDs) is specifically discussed in greater detail in this disclosure. Similarly, many other applications can use composites where highly dispersed nanoparticles are present in a matrix, and one way of characterizing the degree of dispersion is by optical clarity, where higher optical clarity or lack of haziness correlates with better dispersion.

Many of the electrical and optical applications require that these composite materials should be free of water soluble ions to reduce corrosion and elevated temperature degradation. For these applications, the ions in the ionic species are hydrophobic. Many nanoparticle formation processes from inorganic materials use wet-chemical methods that employ acids, bases and metal compounds to catalyze the reactions. This contaminates the nanoparticles with water soluble ionic impurities or unwanted metal ions. Methods to make nanoparticles free of these impurities are disclosed.

One may also use the high index composites (first composite) of this invention as high index filler material by adding to another matrix material (second matrix) of a lower index to make a new composite (second composite) which is opaque. This is similar to increasing the hiding power of polymers and paints by incorporating high index fillers in them. The high index composite fillers of this invention could be used as fillers so that these are deformable during use or processing and replace rigid high index metal oxide fillers. From a processing perspective, substitutes for the hard inorganic fillers that are deformable may allow a better viscosity control, decreasing wear and tear on processing equipment and allow more control on mechanical properties while imparting other benefits. When the first composite material of high index is dispersed in the second matrix, the particles of the first composite material may be added as distinct particles or may melt and phase separate in a desired size and form. The particle size of the first composite material is controlled in the second composite to give high light scattering or opaqueness or hiding power as compared to these properties of the second matrix alone. First composite may be thermoset or a thermoplastic. The second matrix may also be either, but if it is a thermoset, it is crosslinked only after the first composite is added. Processing characteristics (e.g. high shear, high cooling rates, etc.) and other ingredients such as surfactants may be used to control the particle size of the first thermoplastic composite in the second composite. Concepts to make second composites are disclosed.

### SUMMARY OF THE INVENTION

In accordance with the purposes of the present invention, as embodied and broadly described herein, the present invention provides methods of forming high refractive index composite materials that are formed by well dispersed high index nanoparticles in a matrix and also forming of nanoparticles with low water soluble ionic impurities or unwanted metal impurities. This application also discloses methods to make high refractive index ionic liquids that are hydrophobic. Specific applications where these composites and ionic liquids can be used for LED encapsulation and other applications are also disclosed.

### BRIEF DESCRIPTION OF THE DRAWINGS

FIG. 1—Increase in light extraction capability with increasing encapsulant index for a LED;

FIG. 2—Calculation results of the composite RI as a function of volume % of nanoparticles (with an RI of 2.4) and the matrix RI;

FIG. 3—Calculation results of mean scattering length for the composite as a function of volume % nanoparticles and the nanoparticle diameter, for nanoparticles with an RI of 2.4 and a matrix RI of 1.6;

FIG. 4—Calculation of matrix RI for a fixed mean scattering length of 0.25 cm as a function of volume % of nanoparticles and the nanoparticle diameter for nanoparticles with an RI of 2.4;

FIG. 5a—Functionalization of nano-particles and incorporation in a reactive matrix;

FIG. 5b—Functionalization of nano-particles and incorporation in a reactive matrix;

FIG. 6a,b—Schematic encapsulation of (a) an LED and (b) an LED array

FIG. 7a,b—Schematics of LED encapsulation (a) without phosphor particles and (b) with phosphor particles in the encapsulant;

FIG. 8a: —Schematics of a second composite formed by dispersing particles of a first composite in a second matrix;

FIG. 8b: Schematics of a second composite formed by dispersing particles of a deformable first composite in a polymeric matrix, wherein the particles deform when the second composite is deformed.

### DETAILED DESCRIPTION

### Applications of the Invention

Light emitting diodes (LEDs) comprise of a semiconductor emitter which is encapsulated in a transparent matrix. In some LED constructions which are fabricated to produce white light, several emitters that emit in different wavelengths may be combined, or the encapsulant layer may also comprise of phosphor particles that partially absorb the light emitted by the semiconductor at first wavelength or color (e.g. blue light) and then convert that light to second wavelength or color (e.g., green, yellow, red) before it is reemitted. The combination of the different wavelengths or colors of light from either construction results in white light as perceived by the human eye. There may be more than one type of phosphor embedded in the encapsulant to balance the color in the light so as to achieve a specific color rendering index (CRI). A preferred range of CRI for white light is between 60 and 100.

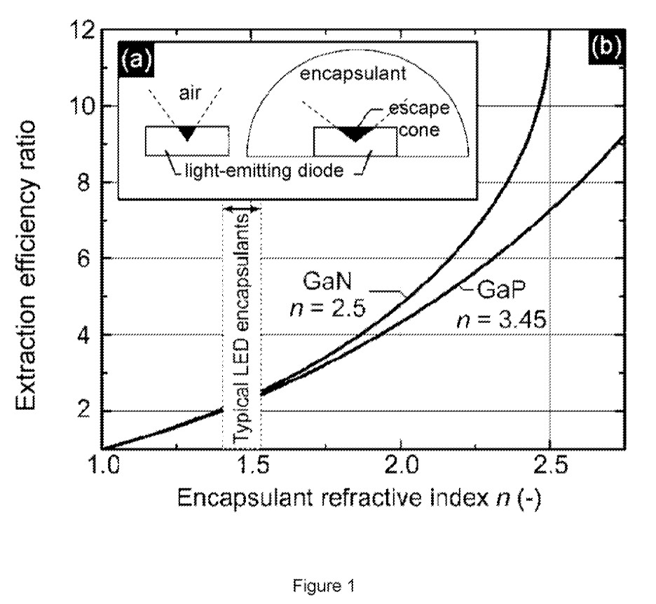

The semiconductors or emitters used to produce light for LEDs, are high refractive index materials, e.g., gallium nitride (RI=2.5), gallium phosphide (RI=3.45), silicon carbide (RI=2.7), aluminum oxide (RI=1.78), and the light extraction efficiency from the semiconductor surface into the encapsulant is limited by the low refractive index of the encapsulant (see FIG. 1, obtained from Mont et al (JOURNAL OF APPLIED PHYSICS 103, 083120 (2008)). Thus higher refractive index encapsulants are desirable which have closer RI to the semiconductors. When phosphors are used in LEDs, these also typically comprise of high refractive index metal oxides (higher in RI compared to the RI of the encapsulants), e.g., some are based on yttrium, aluminum garnets which are cerium doped (YAG:Ce) have a refractive index (˜1.85). These phosphors are used in a size of greater than 100 nm (more typically in a size range of about 1 to 20 microns). Conventional silicone encapsulants have an RI between 1.4 to 1.55, and typical urethanes and epoxy encapsulants range in RI from about 1.5 to 1.58. The scattering of light caused by the mismatch of index between the phosphor and the encapsulant matrix results in halos which reduces color fidelity. Also, beyond a certain phosphor particle concentration, the light intensity decreases due to scattering. Thus for applications with embedded phosphor, encapsulants that match or are close to the RI of the phosphors are very desirable. Preferably the index difference between the phosphor and the encapsulant should be less than 0.15 RI units and more preferably less than 0.05 RI Units.

In addition, LEDs are being targeted for higher brightness applications such as backlights for displays (including TVs), for general illumination (streets, buildings, transportation), etc. Many of these high brightness LEDs also run at a higher temperature. Thus the encapsulants for these have to be able to meet continuous temperatures of 150 to 200° C. The high temperature is accompanied by intense light that is being emitted. Thus the encapsulants have to be thermally and optically stable. Although encapsulants are available in a range of RI from 1.5 to 1.6, these are not thermally stable to 200° C. The encapsulant materials stable to 200° C. are silicones based on dimethyl siloxane backbone that have an RI of about 1.4. Higher RI silicones (RI up to ˜1.54) are available, where some of the methyl groups are replaced by phenyl groups, however, such silicones are generally stable to about 150° C. It will also be desirable to enhance the thermal conductivity of the encapsulants in order to decrease the temperature gradients.

Higher refractive index LED encapsulant materials are those which have an index equal to or higher than 1.60, preferably higher than 1.65 in the wavelength of interest (typically between 400 and 700 nm for LEDs). However, if one is looking for thermally stable encapsulants (to 200° C. and higher) than RI higher than 1.5 can be considered as high index as it is a significant improvement in RI as compared to the currently available options. The encapsulants should be thermally stable for 50,000 hours (or more), which means that the light intensity reduction caused by the encapsulant should not be more than 20% (as compared to the initial value) when it is continuously operated over this time. Industry accepts a total light reduction of about 30% over the life of the LEDs where some of the reduction may come from the aging of other components. One accelerated test involves putting encapsulants on hot junctions (e.g. 175° C.) and then subjecting these to an environmental chamber at 85% relative humidity and 85° C. for 5,000 hours and ensuring that the decrease in light transmission loss (or decrease in the encapsulant transparency) is less than 20%. In some applications the encapsulants contact metallic components subject to corrosion under elevated temperatures and moisture. For these applications, the encapsulants should be free of water soluble ionic impurities to prevent corrosion of the metallic components, e.g. electrical connections to the light emitting semiconductors in LEDs.

In some cases the LEDs that do not have phosphors embedded in the encapsulation layer, also require high index encapsulation to extract the light from the LED chip into the encapsulant. In some cases gradient index materials or several layers (usually about 2 to 6) with various indices are needed (starting with the high index material next to the emitter. Typically the highest index materials is closest to the LED chip and then the refractive index decreases with each successive layer, with the last layer with the least RI having an RI in a range of 1.4 to 1.6. This concept is described more fully by Mont et al (JOURNAL OF APPLIED PHYSICS 103, 083120 (2008) which is included herein by reference. The graded index concept may also be used for those LEDs where the phosphor particles are embedded in one or more of the different layers forming the encapsulant as described above. Another graded index concept which is well known in the industry is called “fried egg geometry”. In this case the higher index material with phosphor is placed on the semiconductor in a thickness of about 10 to 200 microns. On top of this material a second clear encapsulant is placed in a shape of a hemisphere. The RI of the hemisphere is equal to or lower than the encapsulant with the phosphor layer. In many applications it is desired that the encapsulant be placed on the emitter in a form of a hemisphere so that regardless of the encapsulant index, most the light hitting the encapsulant/air interface is at near normal angles and is extracted out. Usually, the size of the semiconductor varies from about a 1 mm diameter emitting area to about 5 mm diameter die with several emitting areas. If a 5 mm diameter area has to be covered with one hemisphere shaped encapsulant, then it is required that the encapsulant be highly transparent in a thickness of up to 2.5 mm. High index encapsulants that are transparent in this thickness suit a large variety of LEDs for encapsulant requirements. One may add additional layers that have particles with specific characteristics in order to scatter the light in a desirable angular distribution and/or to change the CRI (see for example published US patent application 20090065791).

Methods to fabricate high index composites by combining high refractive index nanoparticles in a lower index matrix for use in LEDs are well described in the literature. For example, U.S. Pat. Nos. 6,870,311, 7,259,400, 7,083,490 and published US patent application 2007/0221939 describe the use of LED encapsulants with high index nanoparticles in a lower index matrix. These patents are included herein by reference. In addition, this matrix may comprise of phosphor particles that may be in nano size or larger. These patents and application do not discuss improving dispersability of the nanoparticles by use of ionic compounds and optimizing the optical characteristics by changing the size and the volume fraction of the nanoparticles. US patent application 2008/0210965 also uses nanoparticles in a matrix. This patent application is included herein by reference. In this application a solution of nanoparticles is dried and then impregnated with a binder which percolates between the particles. This is difficult to practice because some of the drying times are long (72 hours), or one has to manipulate extremely delicate nanoparticles skeletons. In all of the above investigations, the refractive index of the matrix (without nanoparticles) did not exceed 1.54. As another example, Shustack et al (U.S. Patent application 2003/0021566) prepared high refractive index waveguides for telecom wavelengths (1550 nm) by combining nano-particles of ceramics (such as those comprising of titania, zinc oxide and tin oxide of about 20 nm in size) and functionalizing their surfaces so that they may be reacted with acrylics. Their approach was primarily to make thick coatings (˜10 microns thick). This patent application is incorporated herein by reference.

In published US patent application 2009/0312457 where molded lenses of high index composites are made by incorporating nanoparticles in a polymeric matrix. The particles were of a core-shell structure (with core having a different composition as compared to the shell). The outer surfaces of the shell were further modified with organic groups to make them more compatible with the polymeric matrices. This patent application is also included herein by reference. The reason for the introduction of shell on the nanoparticles was to avoid coloration generated due to the molecular interaction between the nanoparticle core and the organic modification when it was directly attached to it. In this case the data shows that when the refractive index of the composite increased, its haze factor increased and transparency decreased showing agglomeration of particles and scattering. In this publication the maximum RI of the matrix without the nanoparticles was 1.6.

As would be discussed below the core of this invention is to achieve high refractive index by using high index nanoparticles in an ionic matrix. The RI of these nanoparticles is typically greater than 1.75, and more preferably greater than 2. The nanoparticles are typically water insoluble materials, for example metal oxides (which are preferred), metal sulfates, metal phosphates, etc. Ionic matrices are those that comprise of ionic liquids or polymers with ionic moieties (e.g., the polymeric backbone (or side chains) will have the cations or anions covalently bonded, as is the case for polyelectrolytes). For LED applications the ions should not be water soluble. We have found that the dispersability of the nanoparticles of inorganic materials improves when ionic materials are present in the matrix. This reduces agglomeration and increases loading capacity of the nanoparticles, this improves optical properties in terms of transparency and processing properties. Since the RI of the composite is proportional to the volume fraction of the high index nanoparticles, this combination results in higher RI, while keeping the material optically clear. The composite may comprise of other materials in addition to the ionic component and the high index nanoparticles. These could be another polymer or a monomer that may be later polymerized to solidify the matrix, heat stabilizers, UV stabilizers, viscosity modifiers (including processing solvents which may be removed after the composites are placed in position), surfactants, adhesion promoters, and additional nanoparticles of other materials. As an example for LED encapsulants which are subjected to high temperatures one may add nanoparticles of another material (such as aluminum oxide) to enhance the thermal conductivity of the composite.

The high index (typically greater than 1.6), optically clear composite materials of this invention may also be used for other applications such as instrumentation, cameras, scintillator matrices, optical communication, optical computing, lithography and some specific components are waveguides, beam splitters, diffractive elements, lenses, refractive reflectors, photonic crystals and others. Applications also include high refractive index lenses for eyewear in order to make the lenses thinner and of lighter weight. The high index nanoparticles in the electrolyte for the electrochromic devices can be used to close the gap between the electrolyte refractive index with that of the electrodes it comes in contact with. The enhancement to the RI of the electrolyte reduces reflective losses and multiple images (e.g. ghost images in automotive EC mirrors). For example, some of the electrodes are made of high index materials such as transparent conductors (e.g., indium-tin oxide, fluorine doped tin oxide, doped zinc oxide) or metals or other metal oxide comprising electrodes (e.g. tungsten oxide, nickel oxide). Thus electrolytes with high index (greater as compared to the electrolyte RI without the high index nanoparticles) will result in reduced optical losses (reflections) at these interfaces. This could be particularly important in electrochromic mirrors (e.g., automotive rear view mirrors) and electrochromic windows (e.g. those used for transportation, architectural, display filters and optical eyewear). In some applications, better dispersion of nanoparticles in a matrix could lead to superior properties, e.g. in electronic devices, nanoparticles with electronic properties (e.g. ferroelectric barium titanate) may be used to make higher performing devices by dispersing them in appropriate ionic matrix.

For another set of applications the high refractive index materials can be used in another way. Many applications requiring common plastics and paints use high refractive index inorganic powders (typically titanium dioxide based powders with an average size greater than about 0.1 μm) as fillers to provide increased opacity or hiding power as compared to the raw polymer. Applications include paints, packaging, fibers, instrument and appliance housings, and a variety of industrial and consumer goods. Titanium dioxide based fillers and pigments are available from many sources. Some of these are Tronox Inc (Oklahoma, Okla.), Tioxide pigments from Huntsman (Bellingham, UK) and Dupont Titanium Technologies (Wilmington, Del.). In some cases it is desirable that these fillers/pigments be replaced by other polymers or deformable fillers of high refractive index. This will allow rheological advantages of these polymer composites in terms of lowering the viscosity, reducing abrasion on processing equipment while also allowing flexibility to control the shape of the dispersed phase to provide additional property advantages. The high index composites made using this invention could be used as fillers in other polymers. The high RI composite (or the first composite), are added to a polymer product (second matrix) as an additive to make a second composite. The second matrix by itself is usually clear or has low hiding power. When the high index material is compounded into the second matrix, the high index material (first composite) deforms and breaks up into small domains that scatter light and provide high hiding power to the second composite. The second composite may also require addition of a surfactant or a surface modifier (e.g., block copolymer with one block being compatible with the high index domains of the first composite and the other being compatible with the second matrix) to improve the adhesion between the two phases. Higher concentration of this surface modifier usually decreases the size of the dispersed domains. A preferred average size of the domains for this application is in the range of about 0.1 to 0.5 microns. The high index deformable domains themselves comprise of high index nanoparticles (as discussed below) along with ionic materials and possibly other polymers. It is important that the ingredients chosen for the high index composite should not be miscible with the second matrix so that the high index domains can maintain a separate identity and preserve their high RI within the second composite.

### High RI Composites Using Nanoparticles

The high RI composite comprises of high index nano-particles that are pre-formed and are incorporated in a matrix material, so that the resulting composite has a refractive index between the RI of the matrix and that of the nanoparticles. Some examples of high index particles are amorphous or crystalline metal oxides that contain one or more of the elements typically selected from Si, Ti, Zr, Al, Ta, Zn, Sn, Sb, Zr, Be, Ce, Pb, Ge, Bi Y, Gd and W. Silicon oxide by itself has low RI but it can be combined with others to get high RI. For example, titanium dioxide may be modified with less than 10% of another oxide such as that of Si, Zr or Ta, etc., to reduce its photo-oxidation characteristics. As alternative, titanium oxide may be coated with another metal oxide to reduce its photoactivity. Some of these metal oxides in mixtures or by themselves that can be used are oxides of Si, Zr, Ta and Al. Yet another alternative one may use mixed oxide crystalline compounds with lower photoactivity but high RI, e.g., barium titanate. One may add more than one size of the high index nanoparticles to get better packing. For example if a bimodal size distribution of spherical or near spherical particles is used, smaller nanoparticles are about 70% the size (e.g., diameter) as compared to the larger ones. This allows a higher volume packing percentage of the nanoparticles, which enhances the refractive index of the composite. The use of two different sizes allows the nanoparticle interaction with each other to be reduced by maintaining larger separation between them as compared to only uniformly sized nanoparticles for the same volume fraction loading.

Nanoparticles may also be modified by attaching organic or polymeric groups to their surfaces. This increases the physical and/or chemical compatibility with the matrix. Typically all surface modifications or compositional modifications of titania as described above lead to the reduction in the overall RI of these nanoparticles, thus one has to balance this RI reduction as compared to the other advantages which are achieved.

The refractive index of the composite (η_{comp}) is directly related to the volume fraction and the RI of the nanoparticles (Vₙₚ and ηₙₚ respectively) and that of the matrix (Vₘₐₜᵣᵢₓ is the volume fraction of the matrix and ηₘₐₜᵣᵢₓ is the RI of the matrix), and Vₜₒₜ is the total volume of the composite (also Vₘₐₜᵣᵢₓ+Vₙₚ=1).

η_{Comp}=(Vₙₚ×ηₙₚ+Vₘₐₜᵣᵢₓ×ηₘₐₜᵣᵢₓ)

One may mix several types of nanoparticles, i.e. having more than one type of composition to provide additional property modifications. Of these at least one type of nanoparticles are of high index type, i.e., RI preferably greater than 2. The other type of nanoparticles could influence another property, e.g., electrical conductivity (for this, nanoparticles of indium/tin oxide or zinc aluminum oxide or tin antimony oxide may be used), thermal conductivity (for this, nanoparticles of aluminum oxide and aluminum nitride, may be used) for UV resistance (nanoparticles of cerium oxide, and zinc oxide may be used) and for changing dielectric properties (nanoparticles of ferroelectric barium titanate and lead titanate may be used). The different composition nanoparticles may be similar or different in size or shape. As an example, the higher index nanoparticles such as titania are used in larger size in order to enhance their volume fraction, and the smaller particles (about 70% in size as compared to the larger particles) may be of aluminum oxide to enhance the thermal conductivity. Different sized particles may be used in any proportion, however, in a preferred embodiment the numerical ratio for the two different sized particles is about 1:1, particularly when the smaller particles are about 70% the size of the larger particles in size (e.g. diameter in spherical particles).

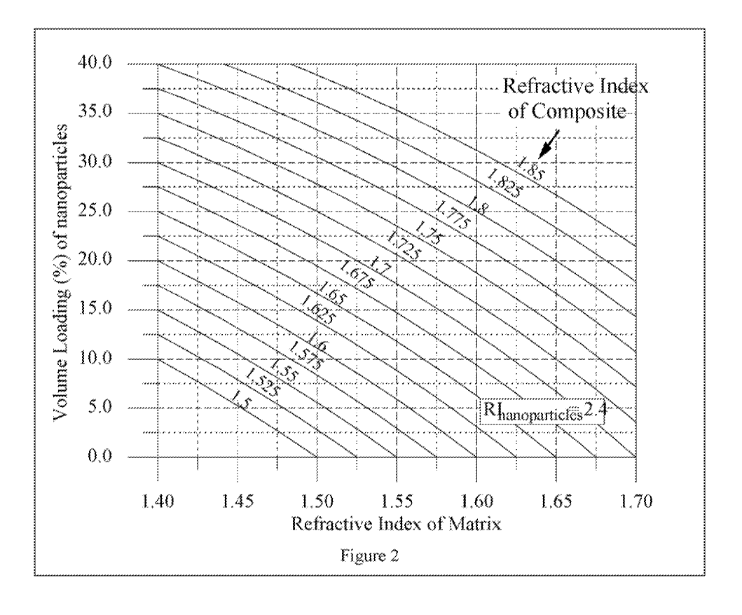

FIG. 2 shows the refractive index of the composite calculated from the above equation for different RI of the matrix and volume loading of the particles. In this diagram the RI of the nanoparticles has been fixed at 2.4. Each of the contour curves shows the RI of the composite where the x-axis and y-axis value on any point on the contour line shows the RI of the matrix and the volume loading of the nanoparticles.

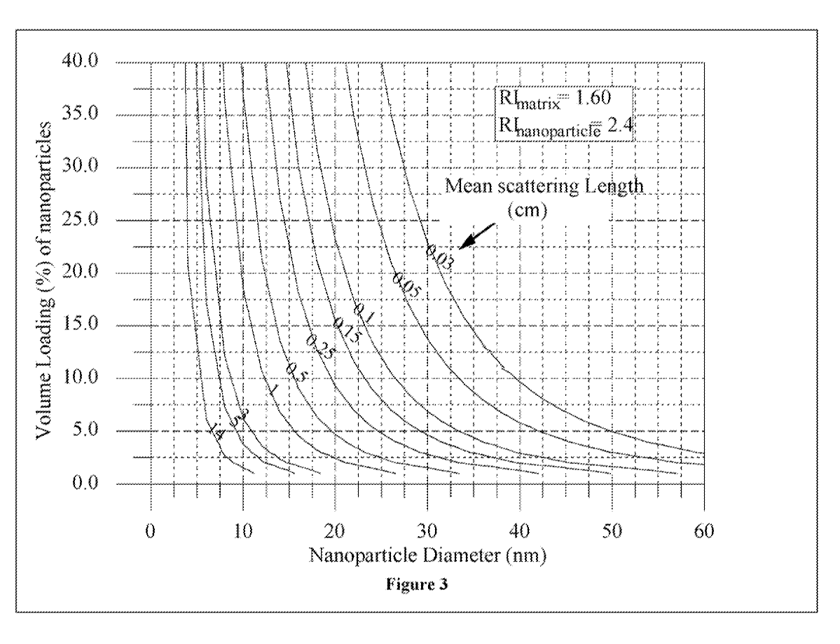

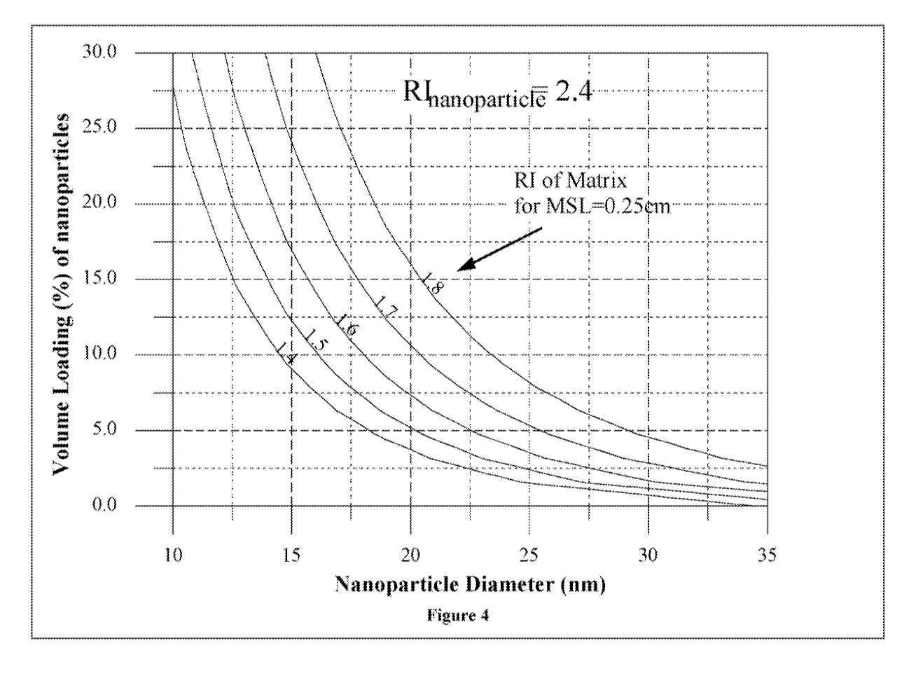

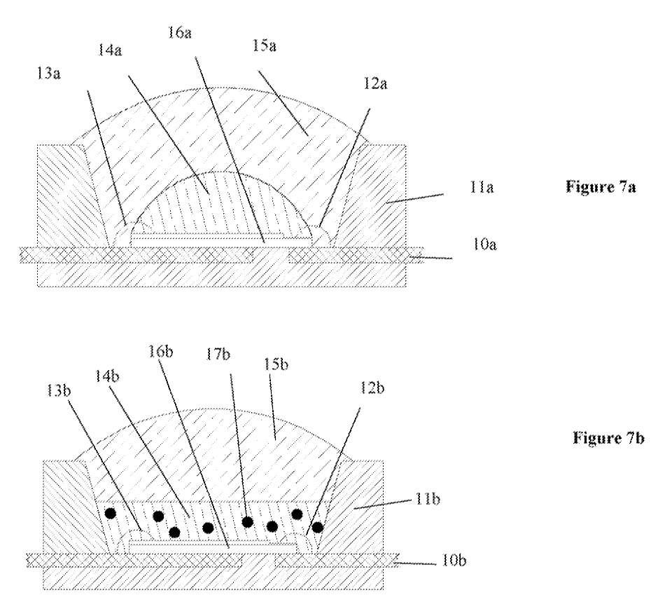

A detailed investigations on using the nanoparticles in the matrix for LED encapsulants was conducted by Mont et al (JOURNAL OF APPLIED PHYSICS 103, 083120, (2008)). In this work titania nanoparticles were added to an epoxy matrix where the matrix had an RI of 1.53. The titania nanoparticles were 40 nm in size with a surface area of 35 m²/g. They showed that even when these nanoparticles were used in a volume loading of 10%, there was significant agglomeration of the nanoparticles that was several microns in size leading to hazy coatings. When a surfactant was used to treat the nanoparticles, the haze reduced but could not be eliminated. In addition, a calculation (FIG. 7 in this reference) showed that even if they formed a composite with fully dispersed 20 nm particles they could only get a scattering length of 27 μm, i.e., they could have only obtained a clear film up to 27 μm in thickness. The equations from this reference were used to estimate how the optical clarity of the composites will change with changing size of the nanoparticles, RI of the nanoparticles, RI of the matrix and the volume fraction loading of the nanoparticles. Using equations from Mont et al calculations were conducted for composites while changing the size and the volume fraction of the nanoparticles to obtain a value of scattering length. A composite thicker than the scattering length is considered opaque. These are theoretical calculations and the exact numbers may be different and opacity changes gradually with composite film thickness, but such concepts allow us to understand the trends of these variables. The calculations are shown in FIG. 3 for a matrix RI of 1.6 and nanoparticle RI of 2.4. This shows several contour lines with a fixed value of mean scattering length in cm. For example a 1 cm thick composite will be clear when the nanoparticle diameter is 12.5 nm and the volume loading is 10%. From FIG. 2, this composite will have an RI of 1.7. Thus, in order to increase the RI the volume % loading of the nanoparticles will have to be increased, and must be accompanied by a lowering of the nanoparticle size or it will become hazy. It is preferred that the nanoparticle size be kept as large as possible without causing haziness, as this keeps a larger distance between them which reduces the interaction between the nanoparticles. If the interaction between the nanoparticles is high, these can stick and form weak networks that fracture easily, or their processing viscosities could be too high. FIG. 4 shows these calculations in a different fashion. Here the contour lines for a fixed scattering length of 0.25 cm are plotted for different RI values of the matrix. The axes are the “particle diameter (nm)” and “volume % loading of nanoparticles”. Each of the contour lines is the limit for a transparent composite for a fixed refractive index of the matrix and a composite thickness (MSL) of 0.25 cm. The region to the left of that curve (or below the curve) results in transparent composite and to the right an opaque one. As an example, this curve shows that if one were to use a matrix with an RI of 1.7 then a volume loading of 15% with a particle size of 17.5 nm (nanoparticle RI=2.4) will just about give a transparent composite (which will have an RI of 1.8 from FIG. 2). Smaller particle sizes at this volume loading or smaller loading at this particle size will always result in transparent composites for well dispersed systems as these will be below or to the left of the curve. It must be remembered that MSL is only a fuzzy guideline around which the transparency changes gradually.

From these calculations, the most preferred range of desired composite RIs for LED encapsulation is in the range of 1.6 and higher to enable higher light extraction. From a processing perspective it is preferred for a loading level of nanoparticles to be below 25%, and from scattering perspective the nanoparticle size is to be smaller than 30 nm. In order to obtain the composites with high optical clarity it is preferred that at most the matrix be about 0.1 to 0.15 RI units less as compared to the final composite. As an example, a matrix with an RI of 1.6 will allow flexibility in terms of nanoparticle loading, particle size and composite thickness to yield clear composites with RI up to 1.75. Alternatively, to obtain clear composites with an RI of 1.8, it is preferred that the matrix RI be 1.65 or higher. Thus, in order to improve the processability and the properties of composite materials where the nanoparticles have to be fully dispersed and yield practically processable solids as coatings or bulk with thickness greater than 10 microns, and most preferably greater than 0.25 cm, many of the above parameters have to be optimized. The preferred nanoparticles for these composites are to be less than 30 nm in size to minimize scattering losses. Second, it is very highly desirable that the nanoparticles be surface treated in order to improve their dispersability preferably by chemically attaching organic groups. Depending on the nature of these organic groups and the matrix characteristics these may also react with the matrix so that the nanoparticles are firmly embedded. Third, one needs to pay close attention to the molecules used for surface modification as these groups or molecules can occupy large volumes and reduce the effective contribution of the nanoparticles towards increasing the refractive index of the composite.

The matrix for these composites can comprise of several other ingredients depending on the application, properties and the processing method used. Other than the ionic species, other ingredients may be selected from UV/light stabilizers, heat stabilizers, antioxidants, flame retardants, surfactants, viscosity modifiers, mildew inhibitors (antimicrobials), particulate fillers, colorants, solvents, monomers, polymers, etc. Some examples of UV stabilizers are benzophenones, benzotriazoles, triazine, hindered amines and some of the antioxidants are hindered phenols and phosphites. A more exhaustive list of various additives can be found in Modern Plastics Encyclopedia (McGraw Hill, New York, N.Y. also see the digital version http://www.modernplasticsworldwide-digital.com/mmpw/2008encyclopedia/) and Plastics Technology Buyers Guide 2009 (Gardner Publications, Cincinnati, Ohio). For LED encapsulants, phosphors, and scattering fillers may also be added. If the LED emits in the UV to excite the phosphor, then the UV stabilizer and the matrix must be chosen carefully so that the desired emitted radiation wavelengths for phosphor excitation are not absorbed by the UV stabilizer and does not degrade the matrix. Solvents will reduce the viscosity of the material during processing, and its evaporation can lead to solidification of the composite. Monomers with or without the solvents will achieve the same, where for the final composite, for properties to develop the solvents are removed and/or the monomer is polymerized. The polymerization schemes may be thermal or radiative polymerization such as using UV, microwaves and Infra-red (IR). The hardness of the final composite will be determined by all of the composite components and their amounts, and the mechanical properties are particularly governed by the type and quantity of nanoparticles, ionic species, monomers/polymers and particulate fillers including phosphors. All of these can be tailored to get soft composite materials with an elastic modulus of about 5 MPa to hard materials with a modulus of 3,000 MPa or above at the use temperature.

For those composites where in-situ polymerization is conducted it is preferred that the monomer in the composition in the mixture be less than 25% by weight of the total and more preferably less than 10%. Polymerization/crosslinking of matrices may be done using various chemistries of addition and condensation polymerization. Addition reactions may be ring opening polymerizations or through the opening of unsaturated bonds and rings. For low shrinkage it is preferred that those monomers be used which have high molecular weight (e.g., functionalized pre-polymers and oligomers), typically greater than 2,500, and preferably greater than 5,000. This has to be balanced by the processing viscosity requirements which may require lower molecular weight of the monomers. Polymeric networks formed by non-hydrolytic solgel route to solidify ionic liquids may be used (Neuoze, M. A., Bideau, J. L., Leroux, F., Veoux, A., A route to heat resistant solid membranes with performances of liquid electrolytes, Chemical communication, p-1082-1084 (2005)). As an example, in this approach tetramethyl orthosilicate was reacted with formic acid to form the solid. This process could be modified by using in part lower functionality materials such as phenyl dimethylsilane, phenyltrimethoxy silane and phenethyltrimethoxy silane. This reduces the crosslink density to increase elasticity of the network former.

For LED applications requiring highest temperature resistance, silicones are preferred, and within silicones, matrices materials with dimethyl siloxane backbones are more preferred. Substitution of phenyl groups for methyl groups increases the RI of the polymer but decreases the thermal stability. An example of two part high purity silicone monomers that are mixed and cured using vinyl end groups and platinum catalysts are OE6450, OE6520, OE6550, OE6630, OE6635, OE6655, JCR6110, JCR6122, OE6336 all from Dow Corning (Midland Mich.). These materials by themselves cure into soft gels, elastomers or hard resins. In addition, the nanoparticles are also preferably surface modified with materials that are compatible with the matrices. Other chemistries such as acrylics, epoxies and urethanes may also be used. Brominated epoxies are preferred in some applications as they result in higher RI, however, they may be colored. Brominated and other epoxy resins are available from Dow Chemical Company (Midland, Mich.). Epoxies are typically cured with anhydrides (e.g., methyl hexa-hydrophtalic anhydride or nadic methyl anhydride) to give low viscosity liquid matrix precursors with 100% resin content. Further, anhydrides may be catalyzed by imidazoles (available from Air Products, Allentown, Pa.), triphosphine imine, etc. The anhydrides can be made in formulations with long pot life (several hours) so as the processing may be controlled well and then cured at elevated temperature (typically between 100 to 150° C.) in a single step or multiple stages. These composites may be produced at a factory as “A” staged resin sheets with all the ingredients but not fully cured. They may have to be refrigerated in this stage to ensure its properties do not change. When it is decided on the final shape and size, several of these are thawed and assembled together as a unified block in a desired shape and fully cured. The final curing may even be done in a site remote from the factory where “Stage A” sheets are produced. To produce large thicknesses, one may even use processes to keep adding uncured sheets (A staged) and curing them one at a time.

Another way of forming clear solid composites is by the use of those polymers (including copolymers) which result in multi-phase structure, meaning two or more phases. These systems will be typically processed from solutions or from the molten state, where these are solidified by removal of the solvent and/or cooling. The matrix formulation comprises both an ionic species and a thermoplastic polymer. The thermoplastic polymer is a block copolymer with different blocks having different solubility properties. One part (or block) of the polymeric chain is readily soluble in the ionic liquid at all temperatures in which the device needs to function, and one other part is insoluble or has low solubility in this temperature range, which forms the second phase. The fall out of the second phase from the solution may result in crystallization of this phase or even a physical or chemical bonding which may require elevated temperature to disperse. Thus, the second phase has a distinct glass transition temperature (T_{g}) or melting point (Tₘ). The presence of the insoluble second phase is similar to the crosslinks which keeps the network of the chains together (just as in thermoplastic elastomers formed by block copolymers). The polymer may have many blocks along the chain where some are more compatible with the ionic species, while the others are not, and in one preferred embodiment triblock polymers are preferred with the end blocks having the lower solubility. For 2 phase systems, the present invention contemplates a first phase as the one which is more compatible or well dispersed in the liquid phase, and the subsequent phases, such as second phase being less soluble in the liquid phase. At least one of the subsequent phases keeps parts of the polymeric chains physically locked which results in an overall solidification of the electrolyte. One has to be careful that for the clear systems, the formation of multiple phases does not lead to scattering of light, i.e., the domain size needs to be smaller than 100 nm. Such systems are more fully described in US patent application US2004/0233537 and in published PCT application WO 2010003138 which are incorporated herein by reference. Some of the polymers that can form multiple phases are polymers and block copolymers of fluorinated materials, polyolefins, acrylonitrile, vinylidene chloride, polyureas, polyurethanes, silicones, etc. Some of the fluoropolymers are fluorinated ethylene propopylene, copolymers of poly vinylidene fluoride, fluoronitaed propylene, ethylene, etc.

### Formation of Nanoparticles and Their Surface Modification

The inorganic nano-particles of high index particles may be formed by a variety of methods, which include solgel methods and plasma processing methods. Sol-gel or wet chemical methods are preferred as these allow easier modification of the surfaces of the nanoparticles. It is possible and preferred to form the nanoparticles in a solution, and these be further processed without isolating and drying so that their surfaces are modified. Several of the solgel methods are listed by [Yu et al; Taekyung Yu, Jin Joo, Yong Il Park, Taeghwan Hyeon, Large-Scale Nonhydrolytic Sol-Gel Synthesis of Uniform-Sized Ceria Nanocrystals with Spherical, Wire, and Tadpole Shapes Angewandte Chemie International Edition, 44(45), 7411, (2005)], solvothermal processes (also called glycothermal processes), reverse micelles, sonochemical methods, microwave heating methods, thermolysis, non-hydrolytic solgel methods (using halide and non-halide precursors). The particles may have a variety of shapes including spherical, ellipsoidal, dendritic, needle like or flake like. For LED encapsulation, nano-particles with spherical or near spherical shapes are preferred. Whatever, the shape of the nanoparticles are, at least one of the dimensions has to be less than 300 nm, and preferably less than 100 nm, and most preferably less than 30 nm. For spheres these dimensions relate to the diameter of the nanoparticles.

Preparation of Metal Oxide Nanoparticles and their Surface Modification (Attachment of proper functional groups) is described in many publications (for example, see published US patent application 20080134939). Proper surface modification ensures that the nano-particles are well dispersed in the desired matrix material without aggregation or coagulation. In published US patent application 2008/0134939 production of nanoparticles is done by carrying out hydrolysis and condensation of metal alkoxides under controlled conditions, and the surface modification with organic groups (e.g., hexoxy) providing amphiphilic properties so that the particles can be dispersed both in polar solvents such as water and non-polar organic solvents. The contents of this published patent application are included herein by reference.

A preferred method to make metal oxide nanoparticles for composites described here uses a medium comprising a ionic liquid, preferably a hydrophobic ionic liquid, water and a metal oxide precursor (e.g., an metal alkoxide, metal acetate, metal alkyls, metal acetylacetonate.). Furthermore, it is preferred not to use additional water soluble acid or a base to catalyze the reaction. The ionic liquid acts as a catalyst in the hydrolysis and/or condensation reactions when metallic precursors are used. These reactions lead to the formation of nanoparticles or a coating of this metal oxide. If desired one may use additional catalysts as an option which are not water soluble. The absence of water soluble acids, bases and metal catalysts when preparing nanoparticles, reduces the chances of contaminating the final composite with water soluble and metal ions, which for example can lead to corrosion of devices and electrical connections. We have been able to form nanoparticles of titanium oxide under these conditions. For the same reasons it is not preferred to use metal halides as precursors or making of nanoparticles (e.g., use of titanium chloride to make titanium oxide nanoparticles, see US patent application 20090061230). This would be the case for LED encapsulation application. Some examples of water soluble acids and bases are hydrochloric acid, nitric acid, sulfuric acid, acetic acid, trifluoroacetic acid, sodium hydroxide, ammonium hydroxide and potassium hydroxide, amines (including tertiary amines). In published US patent application 20090202714, thin composite coatings (several hundred nanometers thick) were made by packing titania up to 60% by volume in monomers and then reacting them. This is a very high volume loading of the nanoparticles. This was achieved by reducing the stickiness of the nanoparticles, i.e. reducing the surface groups, e.g., hydroxyl groups. If there are too many surface groups that can interact with one another, then the nanoparticles can stick and agglomerate. This was done by using a solvothermal approach; a process step which involves treating the nanoparticles under high temperatures (in excess of 100° C.) and usually under pressurized conditions (usually in excess of 5 bars) called solvothermal step. Such processes are also useful for our disclosure and these could be added at the tail-end of our preferred synthesis process in order to decrease the surface active groups. In addition, surface modification of the nanoparticles is preferably conducted at the end of this step.

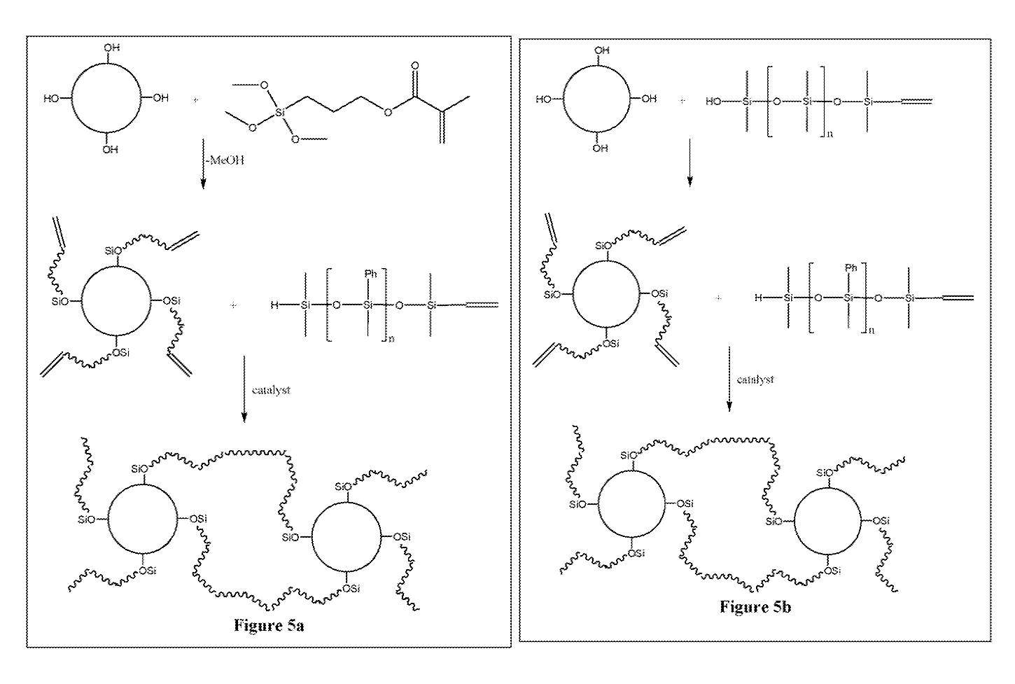

A process schematic showing the surface modification of nanoparticles and their incorporation into the matrix is shown in FIG. 5a. In the first reaction step, a silane coupling agent (3-methacryloxypropyltrimethoxysilane (MPTS)) is reacted with the hydroxyl groups on the nanoparticles. These functionalized nanoparticles are then incorporated into a matrix to form a composite. The matrix comprises of a silicone monomer along with the ionic species and a catalyst that could polymerize the monomer. The silicone monomer has both hydride groups and vinyl groups. These types of groups on monomers are standard materials in two part silicone systems which are usually polymerized (and crosslinked) using a platinum catalyst. When the reaction is complete, the nanoparticles are chemically bonded into the matrix network. FIG. 5b shows similar mechanisms, but here the silane coupling agent is a silicone material with a hydroxyl and a vinyl end group. The hydroxyl group condenses with the nanoparticles and the vinyl end group polymerizes with the matrix silicone polymer. One may also functionalize the surface of the nanoparticles with materials that do not react with the matrix, but provide added compatibility. These may be oligomers (typically molecular weight less than 1,000) that are compatible with the matrix. Some examples are diphenyl siloxane and/or dimethyl siloxane oligomers (as the surface modifiers used in FIG. 5b) but without any reactive vinyl groups. One may also functionalize the surface of the high index nanoparticles with species that are ionic, i.e. one end of the functional molecule is covalently attached to the nanoparticle and the other end or a group within this molecule has an attached cation or an anion. If the cation is attached to the nanoparticle then it is preferable that the anion be the same as that of the ionic liquid in the matrix, and vice-versa if the anion is covalently attached to the nanoparticle surface.

Several coupling agents may be combined together in a solution to treat the nanoparticles to impart surface functionalization. Depending on the concentration of the different coupling agents and their reactivity, the type and quantity of the various surface ligands on the nanoparticle surface can be controlled. This will then control the compatibility and the reactivity of the nanoparticles in the polymer composition they are dispersed in. These coupling agents may be based on different chemistries and may employ organometallics based on silicon, titanium, aluminum and zirconium. One has to be careful about the amount of reactive groups on the surface of the nano-particles. As these nano-particles can act as centers of hyperbranched structures, and if the loading of the nanoparticles and the surface reactive groups is high, the gel point may occur prematurely, resulting in poor processability. Coupling agents such as γ-aminopropyltrimethoxy silane and γ-glycidoxypropyltrimethoxy silane will react with the —OH groups on the surface of the nano-particles at the alkoxy end. The same happens when the amphillic chemistry is used to modify the surfaces. The amine or the glycidoxy end is reactive with epoxy and or curing agents used to cure epoxies. Silanes such as isobutyltrimethoxy silane or methyltriethoxy silane will react with the nanoparticles but the organic part does not react with the matrix. Thus one may use mixtures of matrix reactive and matrix non-reactive silanes to control the eventual reactivity of the nanoparticles.

It is important that the surface functionalization is just sufficient to make the nanoparticles compatible with the matrix or react with the matrix as the case may be. However, one may choose these judiciously to ensure that the refractive index contribution of the nanoparticles is not compromised too much. As an example one can modify the surface of the nanoparticles with methoxy trimethyl silane, methyl trimethoxy silane, N-methylamono propoyl trimetoxy silane, methoxy dimethyl phenyl silane or with methoxy methyl diphenyl silane, hydroxyl terminated polydimethyl siloxane. When the aromaticity of the surface modification increases, so would its index, which will result in composites with higher M. One may also choose a mixture of silanes to suit the application.

Ionic Materials with High RI

Use of ionic species in matrices for composites with nanoparticles improve the dispersion of nanoparticles. These ionic species could be polymers or low molecular weight salts including ionic liquids. We were surprised to find that when the high index nanoparticles were dispersed in matrices comprising ionic liquids the resulting composites were water clear and did not show any agglomeration. For many composites such as for LED encapsulation the ionic species employed should be hydrophobic. Since the composite RI

dependent both on the matrix and the nanoparticle RIs, we prefer to use those hydrophobic ionic liquids for LEDs which have an RI of 1.50 or higher, preferably higher than 1.6. In addition since the high brightness LEDs heat up during the application, it is preferred that those hydrophobic ILs be used which in addition to high RI also have high temperature stability. The preferred matrix materials for the composite should be stable to 200° C. or higher. If the decomposition temperature of these ionic liquids in air is determined by a thermogravimetric scan (e.g., at 10° C./min in air), then the onset temperature for degradation should preferably be greater than 300° C., and more preferably greater than 400° C. Combining ionic liquids (RI greater or equal to 1.5) with high index nanoparticles can result in composites that are well dispersed and have index in excess of 1.7.

Ionic liquids (ILs) are low melting point salts (e.g., salts with melting points below room temperature, although for most practical purposes these salts have a melting point below 300° C., preferably below 100° C., and most preferably below 0° C.). For optical applications, these ionic liquids are clear, i.e., they are not colored. Amongst other advantages, their negligible vapor pressure ensures that these do not evaporate in the application. In a recent publication it was shown that one could make ionic liquids with refractive indices of as high as 2.08 [Deetlefs, et. al. Deetlefs, M., Seddon, K. R., Shara, M., Neotric Optical Media for Refractive Index Determination of Gems and Minerals, New J. Chem, 30, p-317 (2006)] but their use in composites were not described. These ionic liquids were based on imidazolium cations and Br⁻ and I⁻ anions and also compound anions formed by mixing bromides and iodides. Further, many of these were colored. The ionic liquids present limitless opportunities of blending with other salts and ionic liquids to tailor their M. For many optical composites and particularly for LED encapsulation colorless, hydrophobic and those ionic liquids that are also stable to high temperatures are preferred. For making high index composites as is the case for LEDs, it is preferred that the RI of the ionic liquids should be high. Also, to raise the index further, and keep the clarity, the cations and anions are synthesized with high electron density groups, some of which are sulfur, chlorine, bromine and iodine, unsaturated rings (including fused rings such as naphthyls) and cyano moieties. Ionic substances with higher amounts of bromine in the cations can be prepared using standard methodology.

To obtain materials with exact RI one can mix a lower RI ionic liquid with that of a higher RI ionic liquid. From applicant's work applicant has seen that for ionic liquids to be compatible it is preferable that either one of the anion or cation in the ionic liquids being mixed is similar. One may mix ionic liquids and soluble salts of metals of high atomic number. It is preferred that these salts have their anion the same as ionic liquid so that these are soluble or compatible in a wide temperature range. For example when ionic liquid 2-Bromo-1-ethyl-pyridinium tetracyanoborate or 1-(2-bromo-1-(chloromethyl)-1-methylethyl)pyridinium tetracyanoborate is used as a matrix, a compatible salt is added to change the RI. Some of the preferred salts will be tetracyanoborate salts of one or more of bismuth, zirconium, titanium, lanthanum, hafnium, scandanium, yttrium, ytterbium and neodymium. As can be seen, these metals belong to periods 5, 6 and 7 of the elemental periodic table in chemistry or to the rare-earth series. As an example, a solution of 1 ethyl3-methylimidazoliumtrifluoromethanesulfonate (an IL) may be prepared with lanthanum trifluoromethanesulfonate. As another example, if one uses ionic liquids such as phosphonium salts (e.g., see ionic liquids from Cytec Industries sold under the trade name of CYPHOS®, Woodland Park N.J.) one can use soluble salts of the above metals to modify the RI. Some examples of chloride based hydrophobic ionic liquids from Cytec are IL 101 and IL 164 and those based on alkyl phosphate are IL 169. Although these ionic liquids have a water soluble chloride anion, the large size of the hydrophobic ion shields this anion from becoming water soluble. It is preferred (but not necessary) that the anion of the soluble salt matches the anion of the ionic liquid. For LED encapsulation, ionic liquids that are hydrophobic are preferred so that these are less sensitive to the environmental exposure during product use. Although hydrophobicity is influenced by both the anions and cations a large cation or an anion can shadow the effects of the other.

Since one particular class of application for the high index material is in light emitting diode packages or scintillator matrices, one can add these soluble salts by selecting them by putting additional restrictions. Ionic liquids from phosphonium cations usually show good temperature stability, which are more suitable for LED encapsulation. These restrictions being that the cation of the soluble salts be the same as the cation forming the phosphor embedded in the high index material or of the semiconductor that emits light with which the encapsulant is in contact with. For example if one uses YAG:Ce as phosphor one may add soluble salts of yittria, aluminum and cerium (or at least matching one of the cations that forms the phosphor or the semiconductor). Further, these may be added in the same proportion as their solubilities or in proportion to their concentration in the phosphor (or the semiconductor) to reduce ionic migration across these materials in order to avoid corrosion. The phosphor particles and the emitting semiconductors are considered as active materials in the LED.

Cations of interest are phosphonium, imidazolium, pyridinium and thiazolium (where one of the nitrogens in imidazolium is substituted by sulfur) with asymmetric substitution on unsaturated ring are of particular interest, preferably those which have electron rich substitutions e.g., unsaturated ring structures (e.g., phenyl, naphthyl), halogens (e.g Cl, Br and I) sulfur, oxygen and metals (e.g. bismuth, zirconium, titanium, niobium, tantalum europium, lanthanum and neodymium) Phosphonium cations are of particular interest due to their high temperature stability and low toxicity. Some examples of the phosphonium cations with unsaturated ring structure that could be used for LED application are triphenyloctylphosphonium [1], triphenylnaphthylphosphonium [2], triphenyl 1methyl-2[(phenylsulfonyl)methyl]benzene phosphonium [3], trinaphtyl-1-methyl-2-[(phenylsulfonyl)methyl]benzene phosphonium [4] and trinaphthyloctylphosphonium [5], and their chemical structures are shown below. With a judicious choice of anions these could result in temperature stable, stable ionic liquids with an RI in excess of 1.55 and some higher than 1.6. Some of the preferred anions that may be combined with any of these cations are bis(trifluoromethylsulfonyl)imide, acetate (AC), tribromoacetate and trifluoromethylthiobenzene sulfoniums, phosphoniums, cyanoborates, bismuthate and phosphates. The non-halide anions of particular interest are.

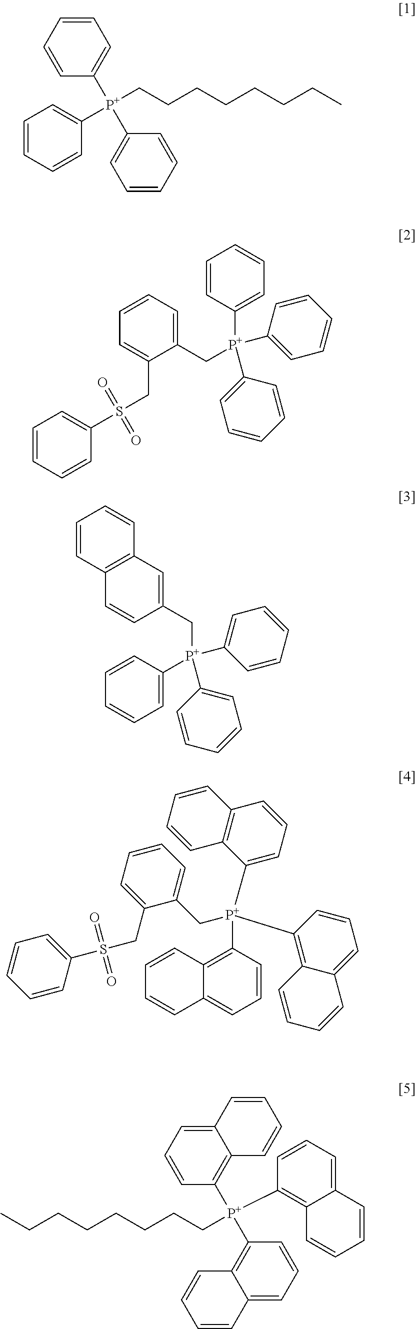

The composites of ionic species and the nanoparticles are preferred as encapsulants for LEDs as they provide higher index, however, one may use only the matrix with the ionic species (or ionic liquids) to form encapsulants for LEDs. As discussed earlier the matrix may comprise of other ingredients including polymers and monomers. These ionic encapsulants may still provide a higher RI as compared to the conventional materials that are currently used in this application. The RI of the encapsulants without the nanoparticle enhancement are preferably greater than 1.55 and more preferably greater than 1.65.

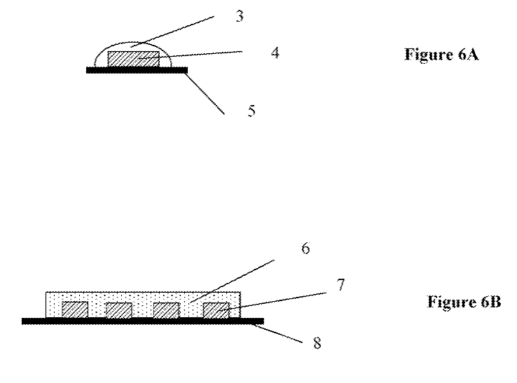

FIG. 6a schematic shows a semiconductor LED 4 on a substrate 5 which may be a housing or a lead frame (the electrical connections are not shown) which is encapsulated with a matrix of high index material 3. This matrix may also be shaped as a lens if desired. FIG. 6b schematic shows a display element comprising of several LED elements (or an array) 7 on a substrate 8 (which may also be a housing or a lead frame) which are covered with a high index material 6. An array of LEDs is used to form displays. Sometimes the substrate is the same semiconductor onto which the emitting areas of LED are fabricated. These high index materials may be used directly or comprise of these materials for use in any optical system where a high index material is required. FIG. 7a shows an individual LED package where the emitting semiconductor is shown as 16a and this is mounted on a lead frame 10a along with a can 11a. The semiconductor is electrically wired to the lead frame using connectors 12a and 13 a. A high index transparent encapsulation material made by this invention 14a is placed over the emitting semiconductor, and is then covered for protection by a transparent material 15a. If the high index material provides enough environmental and mechanical protection then 15a is not required. FIG. 7b shows another type of an LED device that emits white light. The emitting semiconductor is 16b, which is electrically connected to a lead frame 10b via the connections 13b and 12b. The outside protective can is shown as 11b. The high index encapsulant from this invention 14b that has phosphor particles 17b is placed on top of the emitting semiconductor. The semiconductor emits in blue or UV region, and the phosphors convert this light to other colors so that an observer sees white light emanating from the LED. This encapsulant is then covered with an optional protective layer 15b. In both examples i.e., 14a and 14b, the high index and/or the clear protection layers may be shaped as a lens (e.g., hemispherical shape) to direct the light more efficiently.

### Use of High Index Materials as Fillers in Low Index Matrices

One may also use the high index composites (first composite) as high index filler material by adding to another matrix material (second matrix) of a lower index to make a new composite (second composite) which is opaque. The first composite must not be soluble in the second matrix, otherwise a uniform solution will be obtained rather than discrete domains or particles of the first composite embedded in the second matrix. As described below the two can be compatible so that there is good adhesion between the two and one can control the domain size. The filler or the first composite can be made “deformable” by using this invention. “Deformable” means where the shape of the filler could be changed during processing or use. When the second composite is processed, the filler may be deformed and shaped without having the filler made in a specific shape as is done for rigid fillers.

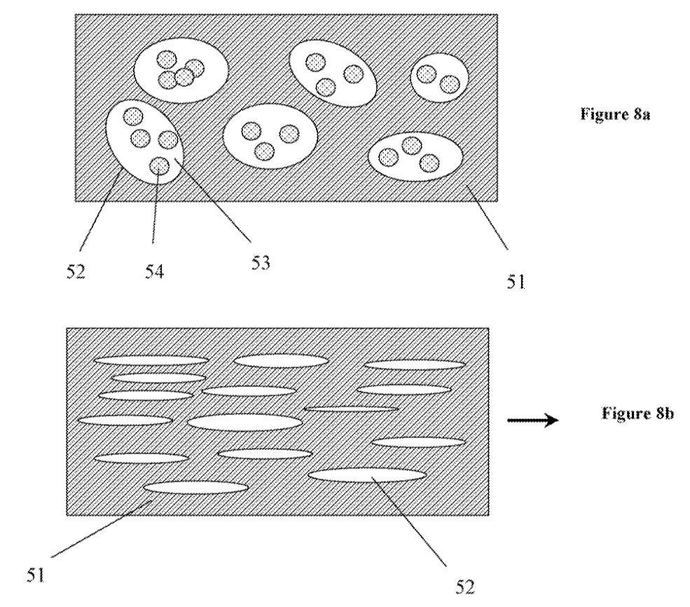

The first composite may comprise ionic materials as discussed before in this invention. This is similar to increasing the hiding power of polymers and paints by incorporating high index fillers in them. The high index composite fillers of this invention could be used as fillers so that these are deformable during use or processing and replace rigid high index metal oxide fillers. From a processing perspective, substitutes for the hard inorganic fillers that are deformable may allow a better viscosity control, decreasing wear and tear on processing equipment and allow more control on mechanical and other properties. When the first composite material of high index is dispersed in the second matrix, the particles of the first composite material may be added as distinct particles or may melt and phase separate in a desired size and form. The particle size of the first composite material is controlled in the second composite to give high light scattering or opaqueness or hiding power as compared to these properties of the second matrix alone. First composite may be thermoset or a thermoplastic. The second matrix may also be either, but if it is a thermoset, it is crosslinked only after the first composite is added. Processing characteristics (e.g. high shear, high cooling rates, etc.) and other ingredients such as surfactants may be used to control the particle size and shape of the first thermoplastic composite in the second composite. Concepts to make second composites are disclosed. Schematic drawing (not to scale) of second composite comprising first composite as fillers is shown in FIG. 8a. This shows a second composite with low RI polymer matrix 51 (or second matrix) and high RI filler (first composite) 52. The first composite is shown in this figure further comprising first matrix 53 and the high RI nanoparticles 54. The first composite matrix may comprise of ionic materials. The first composite may comprise of high RI composites as disclosed in this invention which incorporate ionic materials, polymers and nanoparticles; or the first composite may comprise of high index nanoparticles in a polymeric matrix without ionic materials; or the first composite may comprise of only ionic materials and polymers (e.g., ionic liquid mixed with compatible polymers without high index nanoparticles, where the high RI is obtained mainly due to the high RI of the ionic liquid). Typically the volume percent of the first composite is less than 50%, and more preferably less than 10%. The average size of the dispersed phase or domains (first composite) is in the range of about 0.2 to 30 microns, and preferably the index difference between the first composite and the second matrix is greater than 0.15 units to obtain high degree of opaqueness. If the size of the domains is not spherical then the above size represents the largest dimension of the domain (diameter, length, etc.). Further, the mechanical rigidity or the modulus of the first composite may be lower or higher as compared to the second matrix. FIG. 8b also shows another aspect of this invention where a polymeric second composite (formed by second matrix 51 and the first composite domains 52) is stretched in the direction of the arrow during processing (e.g. in a blow molding, thermoforming or a film forming type operations), and due to this the first composite domains 52 also deformed. The nanoparticles in 52 are not shown, as the first composite may or may not comprise of nanoparticles.

In one embodiment, the first composite is made using thermoset polymer matrix, which is then pulverized in the desired particle size to be added to the second matrix. The second matrix may be a thermoset or a thermoplastic. When such composites are pulverized, preferably cryogenic methods are used to produce the filler. This pulverization process results in low plastic deformation of the material while it is being powdered. A preferred pulverization temperature is below the glass transition or the freezing point of the first composite which needs to be established as this composite comprises of several components. In some cases it may be preferable to have the temperature below all of the secondary relaxation (T_{β}) peaks. In both embodiments since the modulus of the first composite is lower as compared to the inorganic fillers used in the art, such fillers are considered deformable. Expected modulus range of composite fillers at room temperature is in the range of about 5 Mpa to 3,000 Mpa and a more preferred range being 5 to 1000 Mpa. These modulus values are either at use temperature or at a temperature lower than 200° C. so that these are deformable during processing even if at use temperature their modulus exceeds the above range.

In another embodiment the first composite is a thermoplastic which is melt blended with the second matrix (e.g., by extrusion) where both melt during processing and then the high index domains phase separates as the product is cooled. To control the size of the dispersed phase (first composite), one can add surfactants or a compatibilizer in a controlled amount, e.g., a diblock or a graft copolymer with one part (or block or graft) being compatible or being the same as the polymer in the first composite and the second block compatible with or being the same as the polymer in the second matrix.

### Example 1

### Preparation of High Index Matrix with Nanoparticles in an Ionic Liquid

Preparation of ionic liquid (triphenyl octyl phosphonium acetate). To a sure seal bottle was added 1.0 g (0.003813 moles) of triphenylphosphine and 0.7363 g (0.003813 moles) of n-octyl bromide. The bottle was sealed and placed in an oven at 83° C. for one hour. This formed when shaken a clear colorless liquid. The solution was then heated to 130° C. for one hour and cooled to room temperature to form a clear colorless solid with a melting point of 60° C. FTIR analysis of the product was consistent with formation of an intermediate ionic liquid triphenyloctylphosphonium bromide [(Ph)₃C₈H₁₇P⁺Br—]. This ionic liquid had a refractive index at 25° C. of 1.63.

10.43 g (0.0229 moles) of the intermediate ionic liquid (Ph)₃C₈H₁₇P⁺Br— was placed in a flask and 41 ml of deionized water added. Mixture was stirred at room temperature until a white turbid mixture formed. To this was added excess lithium acetate salt (0.0284 moles) [Aldrich Chemical Company 99.99% pure] and the mixture stirred at 25° C. for one hour. It was then heated to 70° C. for one hour with shaking. When left to stand at room temperature two phases separated out a bottom slightly yellow oily phase and a top aqueous phase. Using a separation funnel the oily phase was isolated and washed several times with deionized water and again isolated. It was dried at 70° C. on a rotavap for one hour to give a clear slightly yellow viscous liquid. The ionic liquid i.e. triphenyl octyl phosphonium acetate had a refractive index of 1.56 at 25° C.

The preparation of surface modified particles without the use of acids, bases with water soluble ions or a metal catalyst. 0.257 g of ionic liquid (triphenyl octyl phosphonium acetate) and 3.42 g 1-propanol were mixed in a flask and stirred to a clear homogeneous solution. Afterwards, 2.313 g tetra isopropoxy titanate (TPT) was added into the solution. To hydrolyze TPT a mixture of 0.308 g water and 3.42 g 1-propanol was slowly dropped into it in 2 mins. Upon the completion of the addition of the water solution, the sol was still clear but turned into turbid in 30-60 s. This sol was stirred further for 5 mins and then 0.180 g phenyltrimethoxysilane was dropped into it to perform the surface modification of particles. 2 hrs later after dropping of 0.020 g water, the sol was finally treated at 80-100° C. (the heating apparatus was set to 100° C.) for an hour.

Preparation of the composite casting solution. Next day 0.310 g of the same ionic liquid (triphenyl octyl phosphonium acetate) and 3.1 g sol of surface modified particles above were mixed in a bottle with silicone cap. The solvent in the sol was removed up to 76.3% solid content, i.e. ˜2.59 g liquid, under vacuum (˜20 mbar) at 40° C. for 1-2 hrs. The obtained solid was dispersed by adding of 3.1 g of chloroform into it, which was then used to cast clear films of the composite in a thickness of up to 20 microns with an RI of 1.69.

The present invention may be embodied in other specific forms without departing from its spirit or essential characteristics. The described embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. A material for use as encapsulation of a light emitting diode, wherein the said material is a matrix comprising an ionic material and nanoparticles which are dispersed in the said matrix.

2. A material as in claim 1 wherein the ionic material is selected from an ionic polymer and an ionic liquid and the nanoparticles comprise of a water insoluble metal compound.

3. A material in claim 2, wherein the metal compound is a metal oxide.

4. A material as in claim 1 wherein the refractive index of the said material exceeds 1.55.

5. A material as in claim 4, wherein phosphor particles are embedded in the encapsulation formed by the said material.

6. A material for use as encapsulation of a light emitting diode which comprises of an ionic liquid.

7. A transparent material for use in an optical application wherein its refractive index exceeds 1.6 and the said material comprises of an ionic liquid and metal oxide particles.

8. Deformable filler for increasing the opacity of a polymer wherein the said filler comprises of a composite material of a deformable matrix and nanoparticles and (a) the deformable matrix is insoluble in the said polymer and (b) the said filler has a refractive index that is greater than the refractive index of the said polymer.

9. Deformable filler as in claim 8, wherein the deformable material comprises of an ionic material.

10. Deformable filler as in claim 9, wherein the ionic material is an ionic liquid.

11. Deformable filler as in claim 8, wherein the nanoparticles have a refractive index greater than 2.

12. A process for manufacturing metal oxide nanoparticles using a solution comprising of a metal oxide precursor and an ionic liquid which is not catalyzed using an acid or a base.

13. A process as in claim 12, where the said metal oxide particles are free of water soluble ionic impurities.

14. A process as in claim 12, where the metal oxide precursor is at least one of metal alkoxide, metal acetate and metal acetylecetonate.

15. A process for manufacturing metal oxide nanoparticles using a solution comprising of a metal oxide precursor and an hydrophobic ionic liquid which does not result in formation of water soluble ionic impurities.

16. A process for manufacturing metal oxide nanoparticles or a metal oxide coating using a solution comprising of a metal compound precursor and an ionic liquid, where the said metal compound is hydrolyzed and condensed to form the metal oxide without the use of additional catalyst.

17. A process for manufacturing metal oxide nanoparticles or a metal oxide coating as in claim 16, using a solution comprising of a metal compound precursor and a hydrophobic ionic liquid, where the said metal compound is hydrolyzed and condensed to form the metal oxide without the use of additional water soluble catalyst.
